(19) United States
(12) Patent Application Publication
(10) Pub. No.: US 2019/0181395 A1
(43) Pub. Date: Jun. 13, 2019

(54) COVER FOR A BATTERY CELL

(71) Applicant: Froetek Vermoegensverwaltung GmbH, Osterode am Harz (DE)

(72) Inventors: Marcel DROESSLER, Sonnenstein (DE); Jan Hagen VOIGT, Gifhorn (DE); Sebastian MATHES, Kalefeld (DE)

(21) Appl. No.: 16/092,527

(22) PCT Filed: May 22, 2017
(86) PCT No.: PCT/EP2017/000609

§ 371 Date: Oct. 10, 2018

(30) Foreign Application Priority Data
Jun. 29, 2016 (DE) 102016007861.8

(51) Int. Cl. H01M 2/04; H01M 2/30; H01M 10/48; H01M 2/36

(52) U.S. Cl. CPC H01M 2/043; H01M 2/305; H01M 10/484; H01M 2010/4278; H01M 2/0473; H01M 2/362; H01M 10/486

(57) ABSTRACT

The invention relates to a closure cover over at least one battery cell of an industrial battery, in particular of a drive battery, having two pole openings for passing the battery poles through and having an electrical load in or on the closure cover, wherein an electrical line is arranged on, under or in the closure cover between a first pole opening of one polarity and the electrical load and between a second pole opening of the other polarity and the electrical load in each case, the said electrical lines electrically connecting the poles of the battery cell to the electrical load in order to supply electrical energy to the electrical load, wherein the electrical lines have, as electrical conductors, an electrically conductive plastic.

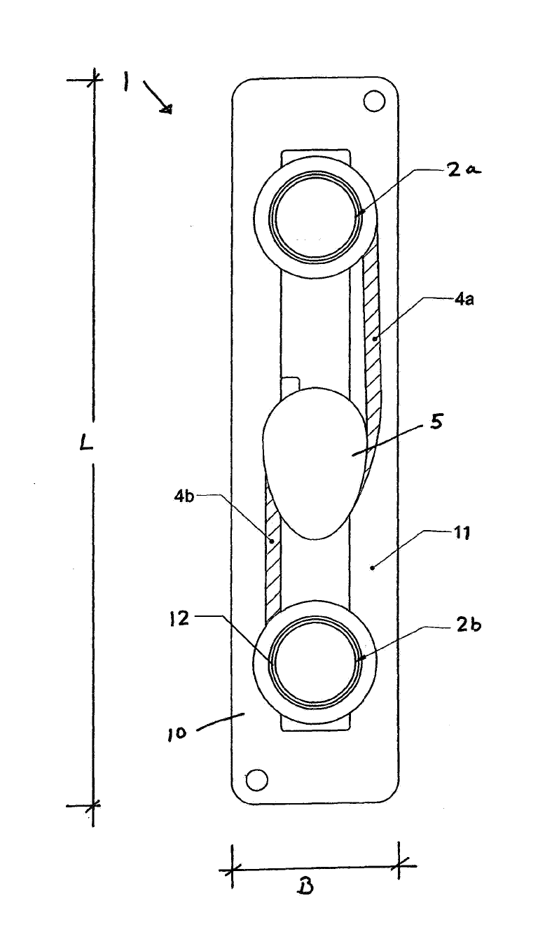

The invention relates to a cap fittable over at least one battery cell of an industrial battery, in particular of a drive battery, and having at least first and second holes through which pass the battery poles and an electrical load in or on the cap.

DE 195 45 833 discloses the connection of each cell in a battery having a plurality of series-connected individual cells to an electrical module, the modules in turn being connected to a central unit. In particular, the individual cell modules are supplied with electrical energy from the respective individual cell via electric lines. The individual cell modules in particular have printed circuit boards are connected via electric lines to the poles of the respective individual cell. Moreover, the electric lines between the module and the individual cell are subject to mechanical damages.

The object of the invention is to provide a cp whose measurement sensors are connected to electric lines protected against mechanical damages, so that the electrical power supply has a simple structure, has a high level of contact security and is free of interruptions without the need of additional contacts. The lines are simple to manufacture and have a high degrees of stability.

This object is achieved, according to the invention, in that a respective electric line is arranged on, under or in the cap between the first hole having a predetermined polarity and the electrical load and between the second hole having a different polarity and the electrical load, lines electrically connecting the poles of the battery cell to the electrical load in order to supply electrical energy thereto, wherein the electric lines are provided with electrical conductors made of an electrically conductive plastic.

In such a solution, the electric lines between the poles of the individual cell and the electrical load are protected against interruptions, since the electric lines are securely conducted in or on the cap. In particular, in this way, a high contact security of the ends of the electric lines is also ensured. It is also important that the electric lines extend on the lower side, upper side and/or within the cap and that the electric lines are provided with an electrical conductor made of electrically conductive plastic, so that a high stability of the lines and a simpler manufacturing may be obtained.

Advantageously the electrical load is fitted into a water fill plug, which is held in a further, in particular a third, hole of the cap. Normally, the electrical load has a sensor.

The electric lines are preferably provided as an electric cable or conductor strip having an insulating sheath. As an alternative, it is proposed that the electric lines are electrical cables or conductor strips without an insulating sheath.

It is preferred that one end or both ends of the electric lines tangentially abut against the holes.

A particularly secure contacting with the poles is obtained when the electric lines are attached to contact rings, fitted into the holes.

An embodiment of an inventive cap for an individual battery cell is shown in the only figure in a bottom view and is detailed in the following.

The inventive cap 1 of an individual battery cell is composed of plastic and is comprises an elongated plate-shaped body 11 having a horizontal disk-shaped bottom face 10 whose length L and width B correspond to the length and width of the battery cell top side, so that the cap completely covers the battery cell. In an unillustrated embodiment, the cap 1 not only covers an individual battery cell, but two or more individual battery cells.

Extending the body 11 and opening at the top and bottom side 10 thereof on one end is a first hole 2a and on the other end a second such hole 2b that fit around the poles of the battery cell. Between both holes 2a and 2b there is a throughgoing hole 5 in the plate 1 holding an insert such as a water fill plug, a voltage indicator, a temperature indicator and/or a fill level indicator in particular with a data transmission device, this device being an electrical load and preferably provided with at least one sensor.

The first hole 2a is connected via a first electric line 4a to the inlet hole 5 so that the unillustrated insert in the hole 5 is electrically connected to the pole in the hole 2a. Analogously, the second hole 2b is electrically connected via a second electric line 4b to the hole 5 and thus to the insert. In this embodiment, the electric lines 4a and 4b extend on the bottom face 10 of the plate-shaped body 11 of the cap 1. Alternatively, however, the lines 4a and 4b may also extend on the top side of the cap 1 or within the plate 11 of the cap.

In particular, the electric lines may lack an outer insulation or may be provided with an insulating sheath. The electric lines are made of an electrically conductive plastic.

In all these embodiments, one end or both ends of the electric lines 4a and 4b extend tangentially to the holes 2a and 2b and 5 and merge with contact rings 12 that are set in the cylindrical inner surfaces of the holes 2a, 2b, and 5, in order to form a good contact.

It is also advantageous, in this case, that the electric line 4a extends approximately parallel to the outer edge of the plate 11 on one side of the three holes and the other, second line extends parallel to the opposite outer edge on the other side of the three holes, so that both lines 4a and 4b are securely separated from each other, thus avoiding leakage currents.

1-8. (canceled)

9. A cap for at least one battery cell having first and second poles of different polarities, the cap comprising:
a cap body formed with first and second holes through which pass the respective first and second battery poles;
an electrical load in or on the cap;
respective first and second electric lines on, under or in the cap and respectively extending between the first hole and the electrical load and between the second hole and the electrical load, the lines electrically connecting the poles of the battery cell to the electrical load in order to supply electrical energy thereto, each of the lines have an electrically conductive conductor made of plastic; and
first and contact rings in the holes connected to the respective electric lines.

10. The cap defined in claim 9, wherein the electric lines extend on the bottom side, on the top side and/or within the cap.

11. The cap defined in claim 9, further comprising:
a water fill plug holding the load, the cap body being formed between the first and second holes with a third hold in which the plug is fitted.

12. The cap defined in claim 9, wherein the electrical load has a sensor.

13. The cap defined in claim 9, wherein the electric lines each are an electrical cable or conductor strip provided with an insulating sheath.

14. The cap defined in claim 9, wherein the electric lines are composed of an electrical cable or a conductor strip with no insulating sheath.

15. The cap defined in claim 9, wherein one or both ends of each of the electric lines tangentially abuts the holes.

16. The cap defined in claim 1 wherein the body is longitudinally elongated and has a pair of long sides, each of the electric wires extending along a respective one of the sides.

17. The cap defined in claim 16, wherein each of the electric wires has an outer end connected to the ring in the respective hole and an inner end connectable to the load.

18. The cap defined in claim 17, wherein the body is formed with a central third hole holding the load, the electric wires having inner ends diametrally exposed opposite each other in the third hole.

19. The cap defined in claim 9, wherein the electric wires extend on an underside of the body turned toward the battery.

20. The cap defined in claim 9, wherein each of the rings is dimensioned to grip the respective pole.
